(19) United States
(12) Patent Application Publication
(10) Pub. No.: US 2025/0070823 A1
(43) Pub. Date: Feb. 27, 2025

(54) METHOD FOR ADAPTING A THRESHOLD FOR A NEAR FIELD COMMUNICATION SYSTEM AND NEAR FIELD COMMUNICATION SYSTEM

(71) Applicant: BCS Access Systems US, LLC, Wilmington, DE (US)

(72) Inventors: Xing Ping LIN, West Bloomfield, MI (US); Matthew Kit TSE, Sterling Heights, MI (US)

(21) Appl. No.: 18/452,640

(22) Filed: Aug. 21, 2023

(51) Int. Cl. H04B 5/00; H04W 52/02

(52) U.S. Cl. CPC H04B 5/77; H04W 52/0241

(57) ABSTRACT

A method for adapting a threshold for a near field communication (NFC) system, the NFC system being implementing in an application in a vehicle, is disclosed. The NFC system comprises a NFC device transmitting a signal via an antenna and receiving a signal via the antenna, wherein the NFC device is kept in a detection mode and checks for a signal to be received. When the signal received exceeds a predefined threshold value, the NFC device is transferred into an active read mode. The method includes performing an identification procedure to determine the cause for the change from the detection mode to the active read mode, and increasing the threshold value and returning to the detection mode if the change to the active read mode was unintended.

### FIELD OF THE DISCLOSURE

Embodiments of the present disclosure generally relate to a method for adapting a threshold for a near field communication (NFC) system, the NFC system being implemented in an application in a vehicle. Further, embodiments of the present disclosure relate to NFC systems.

### BACKGROUND

Near field communication (NFC) is a form of short range communication technology, which so far has mainly been used for mobile payment and ticketing. Recently, the automotive industry has started to implement NFC systems in vehicles for different purposes like vehicle access systems or vehicle ignition systems.

The NFC systems usually comprise a NFC device which is connected to a battery of the vehicle. By presenting a NFC tag within an operation range of the NFC device, a read mode of said NFC device is activated. Actually, the NFC device is operated in a detection mode in order to detect a possible NFC tag. Once a possible NFC tag is detected, the read mode of said NFC device is activated in order to read the NFC tag, thereby obtaining information.

However, the read mode of said NFC device may also be activated due to external interference sources or changes in the environment of the NFC device and/or the vehicle. When the read mode of the NFC device is activated, it requires more energy such that it starts draining the vehicle battery. Especially in case of an unintended activation, this becomes a problem as the lifespan of the vehicle battery may be drastically reduced. While it is a solution to increase the requirements for activation of the read mode of the NFC device, this also decreases the operation range and, therefore, inconveniences the vehicle operator.

Consequently, it is an object of the present disclosure to provide an improved method for operating a NFC system in a vehicle application that saves energy without inconveniencing the vehicle operator.

### SUMMARY

This object is solved by a method for adapting a threshold for a near field communication (NFC) system, the NFC system being implemented in an application in a vehicle, for instance a vehicle access system or a vehicle ignition system. The NFC system comprises a NFC device transmitting a signal via an antenna and receiving a signal via the antenna, wherein the NFC device is kept in a detection mode and checks for a signal to be received. When the signal received exceeds a predefined threshold value, the NFC device is transferred into an active read mode. The method comprises at least the following steps:
a) performing an identification procedure to determine the cause for the change from the detection mode to the active read mode; and
b) increasing the threshold value and returning to the detection mode if the change to the active read mode was unintended.

In other words, the threshold value is adapted based on the reason for the change from the detection mode to the active read mode such that the threshold value is only increased when the change was unintended, e.g., not caused by presenting a NFC tag corresponding to the NFC device. By adapting the threshold accordingly, the overall operation range does not need to be sacrificed while still providing the opportunity to save energy and therefore extend the battery life.

The threshold value may be a simple level threshold, i.e., it does only depend on one parameter, or the threshold value may be based on multiple conditions that must be fulfilled.

Since the NFC system may be implemented in an application of the vehicle, e.g., the vehicle access system or the vehicle ignition system, the NFC device may be placed near a door handle or a B-pillar of the vehicle in case of an implementation as vehicle access system. In case of an implementation as vehicle ignition system, the NFC device may be placed in or near to a dashboard or rather an ignition of the vehicle.

As mentioned above, the NFC device interacts with an intended NFC tag, as the NFC device reads the NFC tag to activate a certain function, for instance granting access to the interior of the vehicle or rather permit ignition of an engine of the vehicle. Generally, the intended NFC tag may relate to a NFC card or a NFC phone.

Typically, the NFC device has two operation modes, namely the detection mode and the read mode. In the detection mode, the NFC device generates an electromagnetic field (signal) and reads an electromagnetic field (signal) in order to detect a modification of the electromagnetic field, particularly an intended modification. In case the intended NFC tag is placed close to the NFC device, the electromagnetic field generated by the NFC device is modified in an intended manner. In general, the NFC device senses any field change. If the field change exceeds a certain threshold condition, the NFC device switches into the read mode for reading any information obtained by the modified electromagnetic field. Obviously, the read mode requires more energy such that the battery is drained faster provided that the read mode is activated too often, particularly due to unintended reasons.

The unintended change to the active read mode may be caused by an interference and/or an environmental change. The interference may be caused by external interference sources such as high-power radar devices, handheld walking talking devices like smartphones, emitter radio devices and the like. Environmental changes are particularly environmental structure changes like metal plates or the like that can alter the signal transmitted by the NFC device. The interferences and/or environmental changes may generate a strong field or alter the signal transmitted by the NFC device such that the generated/altered fields may then be received by the antenna as a signal to change into the active read mode. For this to happen, the generated and/or altered fields need to exceed the predefined threshold value.

According to an example embodiment, the unintended change to the active read mode is determined based on a duration of an environmental change.

Preferably, the NFC device periodically checks for a signal to be received, e.g., a modified electromagnetic field. That means, the NFC device is not continuously checking for a signal whilst in the detection mode, but instead it is only active periodically. This helps saving energy since the NFC device requires less energy when it is not transmitting and/or receiving a signal, e.g., generating an electromagnetic field and reading an electromagnetic field.

In particular, according to an example embodiment, the detection mode of the NFC device is a low-power polling detection mode with a lower power consumption and/or wherein the active read mode is a high power read mode with a high power consumption. Since the NFC device is kept in the detection mode by default, it saves energy compared to the NFC device being in its active read mode. Generally, the NFC device will be in the detection mode, in particular in a standby phase of the detection mode, and periodically transmits a signal, e.g., generates an electromagnetic field, and check for a signal, e.g. an electromagnetic field, exceeding the predefined threshold value during the low power polling detection mode of the detection mode. When the predefined threshold value is exceeded, the NFC device is changed to the active read mode in order to process the signal and react accordingly. Consequently, the high power read mode has a high power consumption that exceeds the low power consumption of the detection mode.

Since the NFC device needs to be able to transmit and receive a signal via the antenna, the NFC device is preferably a transceiver operating in a MHz-range.

In particular, the transceiver operates in a range of 13 MHz to 14 MHz. The preferred operation frequency corresponds to 13.56 MHz.

According to an example embodiment, steps a) and b) are repeated multiple times. This means, the threshold value is continuously increased if the NFC device is changed into its active read mode multiple times unintendedly. By increasing the threshold value repeatedly, the chances of an unintended change to the active read mode are reduced, which effectively increases the life span of the vehicle battery.

Preferably, steps a) and b) are repeated in a cyclic manner. In particular, steps a) and b) are repeated periodically, wherein the period is the same as the period for checking for a signal to be received by the NFC device. However, the cyclic repletion of steps a) and b) may also differ from the periodic repletion for checking for a signal to be received.

According to a preferred example embodiment, when steps a) and b) are repeated more than a predefined number of times, the detection mode is extended. In other words, the time between two successive checks for a signal is increased, i.e. the length of the standby period is increased, in order to avoid a continued change into the active read mode without it being intended. By checking for a signal less frequently, less energy is required.

According to an example embodiment, when a further change into the active read mode due to the unintended change is detected, the threshold value is set to a maximum value and the active period is extended. Preferably, this is done after the detection mode has already been extended. By setting the threshold value to a maximum value, the operation range is minimized, such that the effect of interferences and/or environmental changes has a smaller effect and is less likely to change the NFC device into its active read mode. However, since the operation range is now minimized, also an intended change to the active read mode is less likely and decoding the information transmitted via the signal will take longer such that a longer active period is required.

Preferably, at a maximum threshold value an intended NFC tag modifying the signal transmitted by the NFC device has to be within a predefined range of 5 mm from the NFC device.

While at the maximum threshold value, an unintended change into the active read mode is less likely, an intended change into the active read mode is also harder to achieve since the signal needs to be modified more than during standard operation settings.

According to a preferred example embodiment, the threshold value is restored to the predefined threshold value when no interference is detected. In other words, if the change to the active read mode was intended, the predefined threshold value for the normal operation range is restored and allowing for an operator-friendly experience.

Furthermore, the NFC device may comprise a processing circuit that characterizes a pattern in the signal received and adjusts the threshold value if the pattern has a defined characteristic. This allows for a better and faster adaptation of the threshold value since the processing circuit can adapt the operation range of the NFC device based on the pattern of the signal received. In particular, different reasons for the unintended change into the active read mode are likely to require different strategies regarding the adaptation of the threshold value. By being able to analyze the pattern of the received signal, the processing circuit is able to respond accordingly.

According to a further example embodiment, the NFC device comprises a memory that stores at least the predefined threshold value of the standard operating mode and the maximum threshold value. This ensures that the standard operation range can always be restored by reinstating the standard operation threshold while also making sure that changing to the active read mode is still possible with the intended NFC tag.

According to an example embodiment of the invention, the threshold value is adapted based on a change of a level of the signal received and/or the active read mode over time. This method for adapting the threshold value is particularly valuable for a threshold being based on multiple conditions.

According to a different example embodiment, the threshold value is adapted based on specific signal levels. This embodiment is preferable when the threshold is based on a single parameter.

Preferably, the NFC system is implemented in a vehicle access system. That means the vehicle occupant having the intended NFC tag can approach the car to unlock it. The NFC device will detect the signal altered by the NFC tag and be able to decode the information such that access to the car is granted.

Alternatively, the NFC system may be implemented as a way to start the vehicle engine, namely a vehicle ignition system. Further, vehicle applications include but are not limited to accessing specific parts of the vehicle such as the boot or the bonnet and accessing information of a tire-pressure monitoring sensor.

Generally, the method for adapting a threshold for a NFC system may also be used analogously for a ultra-wideband system and a Bluetooth low energy system.

The object is also solved by a near field communication system implemented in a vehicle application. The NFC system comprises a NFC device with a processing circuit and an antenna. Further, the NFC device has a detection mode and an active read mode, wherein the NFC device is capable of being transferred from the detection mode into the active read mode when a received signal exceeds a predefined threshold value. The processing circuit is configured to adjust the threshold value for activating the active read mode by performing an identification procedure to determine the cause for the change from the detection mode to the active read mode by adjusting the threshold value and returning to the detection mode if the change to the active read mode was unintended.

In other words, the NFC system is capable of adapting the predefined threshold value according to the method specified above.

### DESCRIPTION OF THE DRAWINGS

The foregoing aspects and many of the attended advantages of the claimed subject matter will become more readily appreciated as the same become better understood by reference to the following detailed description, when taken in conjunction with the accompanying drawings, wherein:

FIG. 1 shows a schematic drawing of a near field communication (NFC) system;

FIG. 2 shows a schematic drawing of said NFC system implemented in a vehicle; and

FIG. 3 shows a schematic description of a method for adapting a predefined threshold.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over the embodiments. The illustrative examples provided herein are not intended to be exhaustive or to limit the claimed subject matter to the precise forms disclosed.

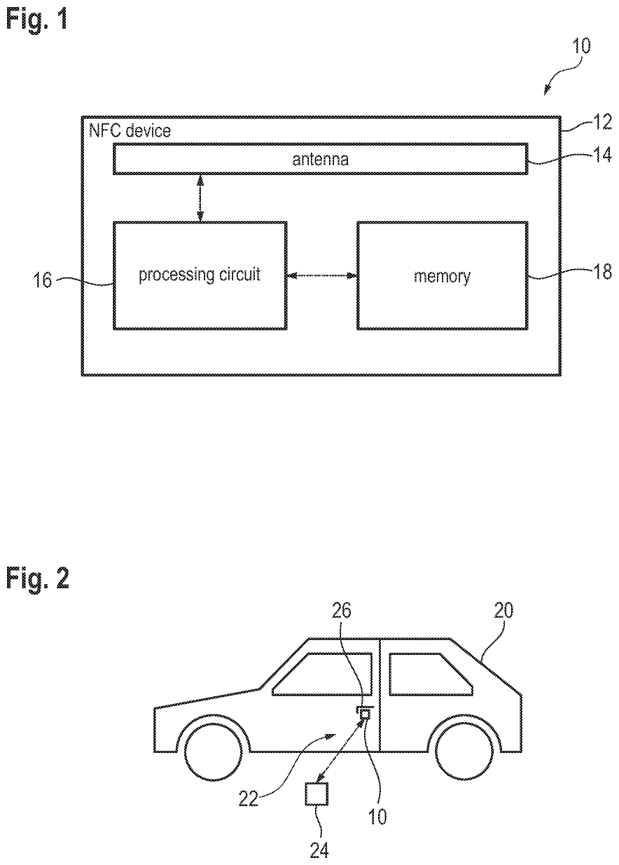

FIG. 1 shows a schematic drawing of a near field communication (NFC) system 10 comprising a NFC device 12 having an antenna 14.

The NFC system 10 further comprises a processing circuit 16, which is connected to the antenna 14 as well as to a memory 18. As shown in FIG. 1, the NFC device 12 also comprises the processing circuit 16 and the memory 18. Alternatively, the memory 18 may be located separately, but being connected with the processing circuit 16 in a signal transmitting manner. In particular, the processing circuit 16 and the antenna 14 are connected in a signal transmitting manner.

Therein and in the following, the term “connected in a signal-transmitting manner” is understood to denote a cable-based or wireless connection that is configured to transmit signals between the respective devices or components.

Since the NFC device 12 needs to be able to transmit and receive a signal via the antenna 14, e.g., generating an electromagnetic field and receiving an electromagnetic field.

Preferably, the NFC device 12 is a transceiver operating in the MHz-range. In particular, the NFC device 12 is a transceiver operating in a range between 13 and 14 MHz, preferably 13.56 MHz.

The NFC system 10 shown in FIG. 1 is intended to be implemented in an application in a vehicle 20, particularly motor vehicles like motorcycles, cars, trucks, busses, etc. This is shown for example in FIG. 2.

In particular, FIG. 2 shows the NFC system 10 implemented as a vehicle access system 22.

Generally, the NFC system 10 further comprises a NFC tag 24 that may interact with the NFC device 12.

For a vehicle access system 22, the NFC device 12 may be placed in proximity to a door handle 26. Alternatively, the NFC system 10 may also be positioned in the B-pillar of the vehicle 20.

By default, the NFC device 12 is kept in a detection mode. The detection mode comprises a stand-by phase and a detecting phase.

During the stand-by phase, the NFC device 12 is inactive and does not require any or only very little energy. During the detecting phase, hereinafter referred to as a low-power polling detection mode, the NFC device 12 transmits a signal via the antenna 14, e.g., generates an electromagnetic field. If the NFC tag 24 is within an operation range of the NFC device 12, the NFC tag 24 will modify the signal transmitted by the antenna 14, namely the generated electromagnetic field, and provide the modified signal, e.g., generate a modified electromagnetic field in an intended manner. During the low-power polling detection mode, the NFC device 12 checks for modified signals, namely the modified electromagnetic field.

In other words, during the detection mode, the NFC device 12 periodically activates the low-power polling detection mode in order to check for a signal to be received, namely the modified electromagnetic field. The rest of the time, the NFC device 12 is in its stand-by phase.

If the NFC tag 24 is within the operation range of the NFC device 12, the antenna 14 will detect the signal modified by the NFC tag 24, namely the modified electromagnetic field. When the modified signal exceeds a predefined threshold value, the NFC device 12 is transferred into an active read mode. While the NFC device 12 is in the active read mode, it can decode the modified signal provided by the NFC tag 24, namely the modified electromagnetic field, which was received by the antenna 14.

The intended NFC tag 24 causes a specific modification of the electromagnetic field, thereby forwarding information to be decoded by means of the NFC device 12.

In the vehicle access system 22, permission to access the vehicle 20 is granted when the NFC tag 24 is within the operating range of the NFC device 12.

Due to interferences and/or environmental changes, the antenna 14 of the NFC device 12 may receive signals that were unintentionally modified, namely such that the NFC device 12 is unable to decode the modified signal, e.g. the modified electromagnetic field.

Such external interference sources may be but are not limited to high-power radar devices, handheld walking talking devices such as smartphones, and amateur radio devices. Furthermore, environmental changes such as metal plates and the like may alter the signal.

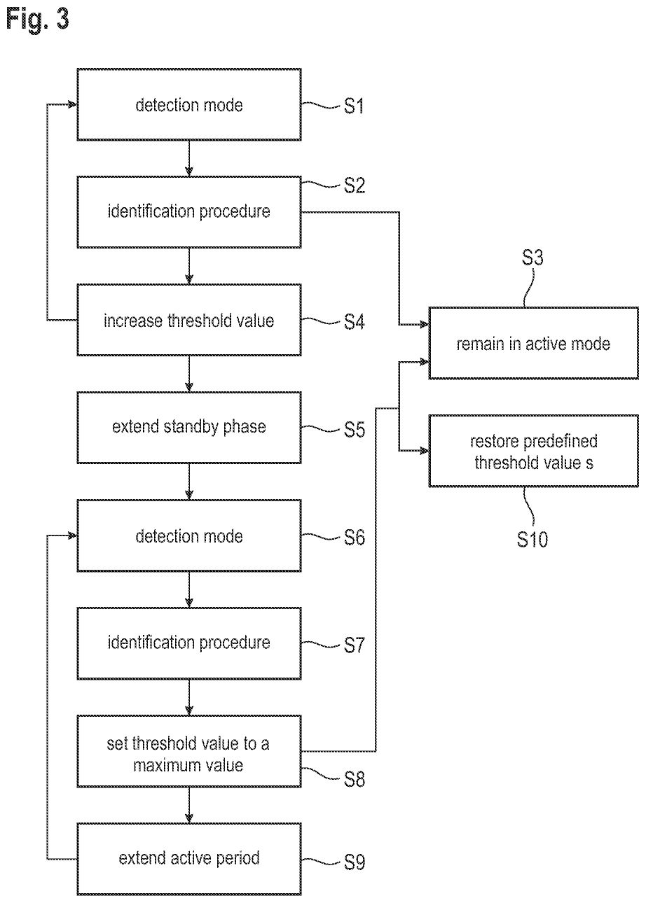

In order to avoid the NFC device 12 being transferred into the active read mode based on an unintentionally modified signal, in which the NFC device 12 tries to decode the modified signal received, the threshold can be altered based on the method schematically shown in FIG. 3.

As seen in FIG. 3, if the NFC device 12 receives a signal exceeding the predefined threshold during the detection mode, in particular during the low-power polling detection mode, in a first step S1, the processing circuit 16 performs an identification procedure to determine the cause for the change from the detection mode to the active read mode according to a step S2.

In case the change was intended, namely due to the (intended) NFC tag 24, the NFC device 12 will be able to decode the modified signal and, therefore, remains or is transferred into the active read mode such that the signal can be decoded. This is shown in step S3.

However, if the change from the detection mode to the active read mode was due to an unintentionally modified signal, e.g. the NFC device 12 will be unable to decode the modified signal, the threshold value is increased and the NFC device 12 is transferred back into the detection mode according to step S4.

This may be done for multiple periods of the detection mode, such that the threshold value is continuously increased. In particular, the identification procedure as well as the increase of the threshold value is repeated in a cyclic manner wherein the cycle length may correspond to the period for activating the low-power polling detection mode.

If the steps S1, S2, and S4 are repeated more than a predefined number of times, the stand-by phase of the detection mode is extended according to step S6. This means, the standby phase, i.e. the period, between activating the low-power polling detection mode during which the NFC device 12 searches for a modified signal is increased additionally to increasing the threshold value as shown in steps S4 and S5.

The predefined number of times the identification procedure and the increase of the threshold value are repeated is preferably lower than five times, even more preferably it is two times.

In case of a further unintended change, see steps S6 and S7, from the detection mode to the active read mode after the stand-by phase was extended, the threshold value is set to a maximum value in a step S8 and the active read period is extended in a step S9.

Every increase of a threshold value as well as the extension of the stand-by phase is intended to save energy and therefore extend the lifetime of the vehicle battery.

However, by setting the threshold value to the maximum value, the active period needs to be extended since the operation range of the NFC device 12 decreases with an increase in the threshold value. That means that the maximum threshold value equals the minimal operation range. In particular, at the maximum threshold value, the intended NFC tag 24 modifying the signal transmitted by the NFC device 12 has to be within a predefined range of 5 mm from the NFC device 12, particularly its antenna 14. Since the vehicle occupant is not aware at what value the current threshold value is defined, the active period needs to be extended such that the NFC tag 24 can still be detected by the NFC device 12.

If at any point, no interference and/or no environmental change is detected, the threshold value is restored to its predefined value according to step S10. This is possible since the memory 18 connected to the processing circuit 16 stores at least the predefined threshold value of the standard operating mode as well as the maximum threshold value.

By having the maximum threshold value being stored in the memory 18, it can be ensured, that the operating range of the NFC device 12 remains large enough for the NFC device 12 to detect the NFC tag 24. In particular, the maximum threshold value takes into account the position of the NFC device 12 in the vehicle 20 as well as the materials separating the NFC device 12 from the corresponding NFC tag 24.

In order to optimize the adaptation of the threshold value, the processing circuit 16 is able to characterize a pattern in the signal received via the antenna 14 and adjusts the threshold value depending on said pattern if the pattern has a defined characteristic.

By identifying patterns in the received signal, it may be possible to reduce the number of times an identification procedure needs to be repeated and directly adjusts the threshold value based on the characteristics of the pattern. Note that this is also only possible if the NFC device 12 comprises the memory 18.

In particular, since the threshold may be based on a simple threshold level or on different conditions, the processing circuit 16 can identify the required threshold change and adapt the threshold value accordingly.

Furthermore, some environmental changes occur only for a short period of time, such that the processing circuit 16 is also able to adapt the threshold value based on the duration of an environmental change.

Analogously to the vehicle access system 22, the NFC system 10 may be implemented in further applications in a vehicle 20. The NFC device 12 could alternatively be placed near an ignition or a dashboard of the vehicle 20, such that the vehicle 20 may be started by bringing the NFC tag 24 within the operation range of the NFC device 12.

Using the NFC system 10 to grant access to a tire-pressure monitoring (TPM) sensor is also possible.

Furthermore, as an alternative to a general vehicle access system 22 as shown in FIG. 2, the NFC device 12 may be placed in proximity to the boot or the engine bonnet such that access to either is only granted with the NFC tag 24 corresponding to the NFC device 12.

Furthermore, the method for adapting the predefined threshold value may also be applied to ultra-wideband (UWB) systems, as well as Bluetooth low energy (BLE) systems.

Certain embodiments disclosed herein, particularly the respective system(s), utilize circuitry (e.g., one or more circuits) in order to implement standards, protocols, methodologies or technologies disclosed herein, operably couple two or more components, generate information, process information, analyze information, generate signals, and codes/decodes signals, converts signals, transmits and/or receives signals, controls other devices, etc. Circuitry of any type can be used.

In an example embodiment, circuitry includes, among other things, one or more computing devices such as a processor (e.g. a microprocessor), a central processing unit (CPU), a digital signal processor (DSP), an application specific integrated circuit (ASIC), a field programmable gate array (FPGA), a system on a chip (SOC) or the like or any combinations thereof, and include discreet digital or analog circuit elements or electronics, or combinations thereof. In an embodiment, circuitry includes hardware circuit implementations (e.g. implementations in analog circuitry, implementations in digital circuitry, and the like, and combinations thereof).

In an example embodiment, circuitry includes combinations of circuit and computer program products having software or firmware instructions stored on one or more computer-readable memories that work together to cause a device to perform one or more protocols, methodologies or technologies described herein. In an embodiment, circuitry includes circuits, such as, for example, microprocessors or portions of microprocessors, that require software, firmware, and the like for operation. In an embodiment, circuitry includes one or more processors or portions thereof and accompanying software, firmware, hardware, and the like.

The present application may reference quantities and numbers. Unless specifically stated, such quantities and numbers are not to be considered restrictive but exemplary of the possible quantities and numbers associated with the present application. Also in this regard, the present application may use the term “plurality” to reference a quantity or number. In this regard, the term “plurality” is meant to be any number that is more than one, for example two, three, four, five, etc. The terms “about”, “approximately”, “near”, etc., mean plus or minus 5% of the stated value.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for adapting a threshold for a near field communication (NFC) system, the NFC system being implement in an application in a vehicle, the NFC system comprising a NFC device transmitting a signal via an antenna and receiving a signal via the antenna, wherein the NFC device is kept in a detection mode and checks for a signal to be received, wherein the NFC device is transferred into an active read mode when the signal received exceeds a predefined threshold value, the method comprising:
a) performing an identification procedure to determine the cause for the change from the detection mode to the active read mode; and
b) increasing the threshold value and returning to the detection mode if the change to the active read mode was unintended.

2. The method according to claim 1, wherein the unintended change to the active read mode is caused by an interference and/or an environmental change.

3. The method according to claim 1, wherein the unintended change to the active read mode is determined based on a duration of an environmental change.

4. The method according to claim 1, wherein the NFC device periodically checks for a signal to be received.

5. The method according to claim 1, wherein the detection mode of the NFC device is a low power polling detection mode with a low power consumption and/or wherein the active read mode is a high power read mode with a high power consumption.

6. The method according to claim 1, wherein the NFC device is a transceiver operating in a MHz-range.

7. The method according to claim 6, wherein the transceiver operates in a range of 13 MHz to 14 MHz.

8. The method according to claim 1, wherein steps a) and b) are repeated multiple times.

9. The method according to claim 1, wherein steps a) and b) are repeated in a cyclic manner.

10. The method according to claim 1, wherein, when steps a) and b) are repeated more than a predefined number of times, a standby phase of the detection mode is extended.

11. The method according to claim 1, wherein, when a further change into the active read mode due to the unintended change is detected, the threshold value is set to a maximum value and the active period is extended.

12. The method according to claim 1, wherein at a maximum threshold value an intended NFC tag modifying the signal transmitted by the NFC device has to be within a predefined range of 5 mm from the NFC device.

13. The method according to claim 1, wherein the threshold value is restored to the predefined threshold value when no interference is detected.

14. The method according to claim 1, wherein the NFC device comprises a processing circuit that characterizes a pattern in the signal received and adjusts the threshold value if the pattern has a defined characteristic.

15. The method according to claim 14, wherein the NFC device comprises a memory, and wherein the memory stores at least the predefined threshold value of the standard operating mode and the maximum threshold value.

16. The method according to claim 1, wherein the threshold value is adapted based on a change of a level of the signal received and/or the active read mode over time.

17. The method according to claim 1, wherein the threshold value is adapted based on specific signal levels.

18. The method according to claim 1, wherein the NFC system is implemented in a car access system.

19. A near field communication (NFC) system, the NFC system being implemented in an application in a vehicle, the NFC system comprising a NFC device with a processing circuit and an antenna, wherein the NFC device has a detection mode and an active read mode, wherein the NFC device is capable of being transferred from the detection mode into the active read mode when a received signal exceeds a predefined threshold value, and wherein the processing circuit is configured to adjust the threshold value for activating the active read mode by performing an identification procedure to determine the cause for the change from the detection mode to the active read mode and by adjusting the threshold value and returning to the detection mode if the change to the active read mode was unintended.
